(19) United States
(12) Patent Application Publication
(10) Pub. No.: US 2022/0127551 A1
(43) Pub. Date: Apr. 28, 2022

(54) Suspension Medium for Improved Grit Delivery in Vapor Blast Operations

(71) Applicant: Cleaner Blast, LLC, Gonzales, LA (US)

(72) Inventors: Jerry L. Fenley, JR., Gonzales, LA (US); Kirk Chrisman, Sugar Land, TX (US)

(21) Appl. No.: 17/083,013

(22) Filed: Oct. 28, 2020

(51) Int. Cl. C11D 17/00; C11D 7/26; C11D 7/20

(52) U.S. Cl. CPC C11D 17/0013; C11D 7/20; C11D 7/268

(57) ABSTRACT

A suspension medium for improved grit delivery in vapor blast operations sets forth addition of a suspending-agent to a blast solution whereby solids are maintained in suspension absent agitation or mixing for at least 60 hours. The suspending agent increases the viscosity and/or density of the blast solution to increase the buoyancy force and/or acts as a dispersant and/or surfactant to maintain suspension of solids in solution over the extended time period. Different concentrations of suspending-agent may be employed with different grit and solid sized particles, depending on the application of vapor blasting at hand. The suspending-agent is preferably biodegradable.

### BACKGROUND OF THE INVENTION

Vapor blasting practices are well established in the art. Typically, water and grit, or other liquid and small-sized particles, as case may be, are combined in a blast pot and introduced into a stream of pressurized air for forcible ejection via a directable nozzle for scouring and cleaning surfaces. A principal problem of this established method of wet air or vapor blasting is that grit particles tend to settle out of suspension in the blast solution is in the blast pot, whereby agitation or mixing of the blast pot is required to maintain suspension of the grit particles. Such mixing or agitation reduces time for blasting operations.

What is needed is a suspension medium for improved grit delivery in vapor blast operations that includes a suspending-agent additional to the water (or other liquid) in the bast pot, whereby suspension of the grit particles is maintained in the blast solution without the need for repeatedly remixing the supply or agitating the blast pot. The suspending-agent is preferably biodegradable, nontoxic, and readily available.

### FIELD OF THE INVENTION

The present invention relates to a suspension medium for improved grit delivery in vapor blast operations, and more particularly, to a suspension medium for improved grit delivery in vapor blast operations that comprises a suspending-agent added to the blast solution to maintain suspension of grit particles by increasing the bouyancy force of the liquid and/or dispseral of the grit particles in solution.

### SUMMARY OF THE INVENTION

The present suspension medium for improved grit delivery in vapor blast operations, described subsequently in greater detail, is devised to maintain suspension of grit particles in the blast solution whereby blasting operations are maintainable without requiring agitation or remixing of the blast pot over extended periods.

As used herein throughout, the term “blasting solution” is taken to mean the combination of liquid and solid materials added to a blast pot for wet air or vapor blasting operations. Most commonly, the blasting solution is contemplated to comprise water and grit particles, that is sand-sized, coarse, medium, and fine, mineral solids. For a more detailed account of example embodiments comprising the “blast solution,” please see below.

Grit is typically added to water (or other solution or liquid) to form a blast solution at a weight ratio of 1 part grit to 3 parts water. The present invention is contemplated for use across a range of such weight ratios, from 1 part grit to 1 part water (or other solution or liquid) to 1 part grit to 5 parts water (or other solution or liquid), as case may be. Other ranges of blast solution composition by weight are contemplated as in scope of the present disclosure, the inventive step of adding a suspending-agent to the blast solution to maintain increased dispersal of the grit in solution and prevent settling remaining unaffected by the general range of compositions wherein the suspending agent is mixed. It should be noted that the same effects evincible in data herein provided are reproducible by altering the concentration of the suspending agent added to the blast solution in proportion to, or relative to, the particular weight ratio of grit to water (or other solution or liquid) comprising the blast solution. The data herein presented below in discussion of the detailed description of the drawings refers to a preferred embodiment of a blast solution comprising, by weight, 1 part grit to 3 parts water. But this composition is provided for purposes of example only and should not be considered as limiting.

As used herein throughout, the term “suspending-agent” is taken to mean a substance added to the blast solution that maintains suspension of solid particles in the solution for an extended time relative the time taken for such solids to settle absent addition of the suspending-agent. As used herein throughout, the suspending-agent may increase the viscosity or density of the blasting solution, thereby to increase the buoyancy force of the solution. Alternatively, the suspending-agent may act as a dispersant or surfactant to maintain solid particulates in suspension.

In an example embodiment contemplated herein, the suspending-agent is contemplated to be a thickening agent whereby the viscosity and/or density of the blasting solution is increased and grit particles are maintained suspended in the blast solution for extended periods of time relative the time taken to settle undisturbed in blast solution absent the addition of the said suspension agent.

In an example embodiment set forth herein the suspension agent is contemplated to be xanthan gum in solution at a range of 1 to 3% by weight, and, in a preferred embodiment, about 2%. However, other ranges and other thickening agents are contemplated for use in the present invention whereby the buoyancy force of the blast solution is increased to maintain suspension of solid particles therein. It should be noted that xanthan gum is already produced at scale for industrial applications. It is biodegradable, readily available, and therefore economically efficient.

Blasting solutions having on the order of 1.5 to 2.0% suspending-agent added by weight appear to maintain suspension of 100% of sand-sized solids for a minimum of 2 hours. After 2 hours, a small proportion of settlement (approximately 5 to 10%) of solids in-use with the blasting solution having 1.5% suspending-agent is evincible. However, blasting solution having 2.0% suspending-agent maintains suspension of all solids for at least 38 hours in all trials, with the exception of blast solution having GMA XTREMEBLAST® garnet solids (see FIG. 3) wherein approximately 5% settled after 12 hours.

Thus blasting solution at 1 part girt to 3 parts water and having 1.5 to 2.0% suspending-agent by weight, wherein the suspending-agent is xanthan gum, is a preferred embodiment of the present disclosure. However, such an embodiment is not intended to be limiting of the application of the novel technology herein described, various formulations of blasting solution contemplated for use between different solids for vapor blast operations. For example, where a 1.5% suspending-agent blast solution is efficacious in maintaining suitable suspension of solids in the associated blasting solution for a reasonable time, the 1.5% suspending-agent blast solution may be preferred. Thus, the present invention contemplates a variety of blasting solutions with suspending-agent concentrations matched for use with particular solids or class of solids. For example, micro-fine solids, such as VITRO® Mineral LA500 Glass Powder (at a range of between 10 and 40 μm) may be effectively suspended (with 90% solids remaining in suspension) for up to 60 hours even with 1.0% suspending-agent. Thus, the present method herein set forth contemplates a range of suspending-agent concentrations for use across particular size classes of solids, as well as compositions of blast solution by weight, typically employed in vapor blast operations.

Thus has been broadly outlined the more important features of the present suspension medium for improved grit delivery in vapor blast operations so that the detailed description thereof that follows may be better understood and in order that the present contribution to the art may be better appreciated.

Objects of the present suspension medium for improved grit delivery in vapor blast operations, along with various novel features that characterize the invention are particularly pointed out in the claims forming a part of this disclosure. For better understanding of the suspension medium for improved grit delivery in vapor blast operations, its operating advantages and specific objects attained by its uses, refer to the accompanying drawings and description.

### BRIEF DESCRIPTION OF THE DRAWINGS

### Figures

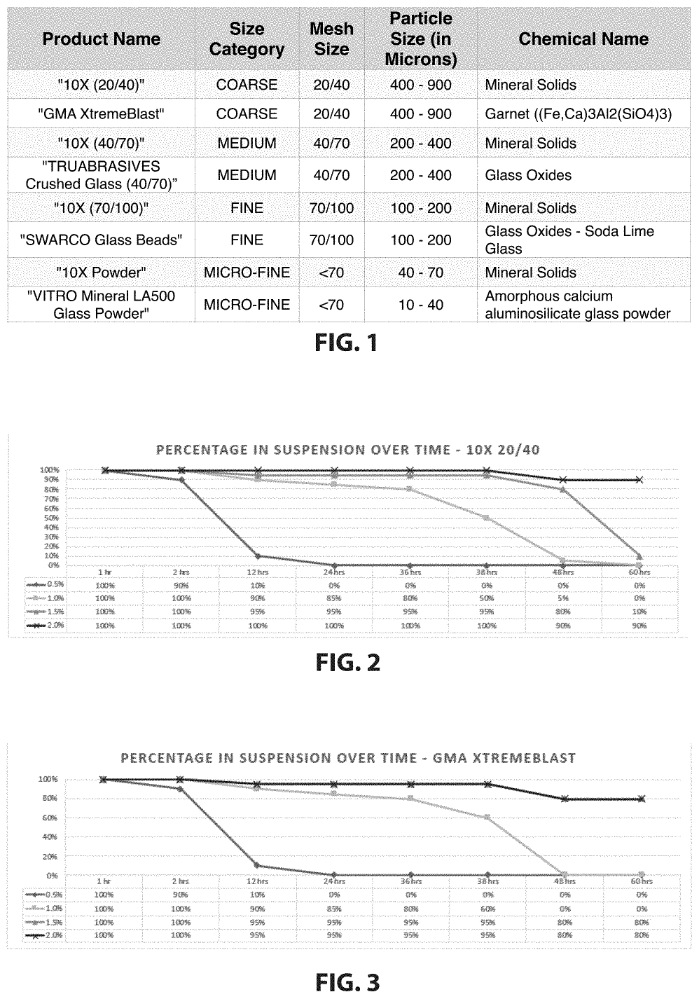

FIG. 1 is a table of various solid particles used with the present invention.

FIG. 2 is a graph showing the percentage of 10× (20/40) mineral solids (400 to 900 μm) in suspension over time in blast solutions having between 0.5 and 2% of the suspending agent added by weight.

FIG. 3 is a graph showing the percentage of GMA XtremeBlast® mineral solids (Garnet (Fe,Ca)₃Al₂(Sio₄)₃) (400 to 900 μm) in suspension over time in blast solutions having between 0.5 and 2% of the suspending agent added by weight.

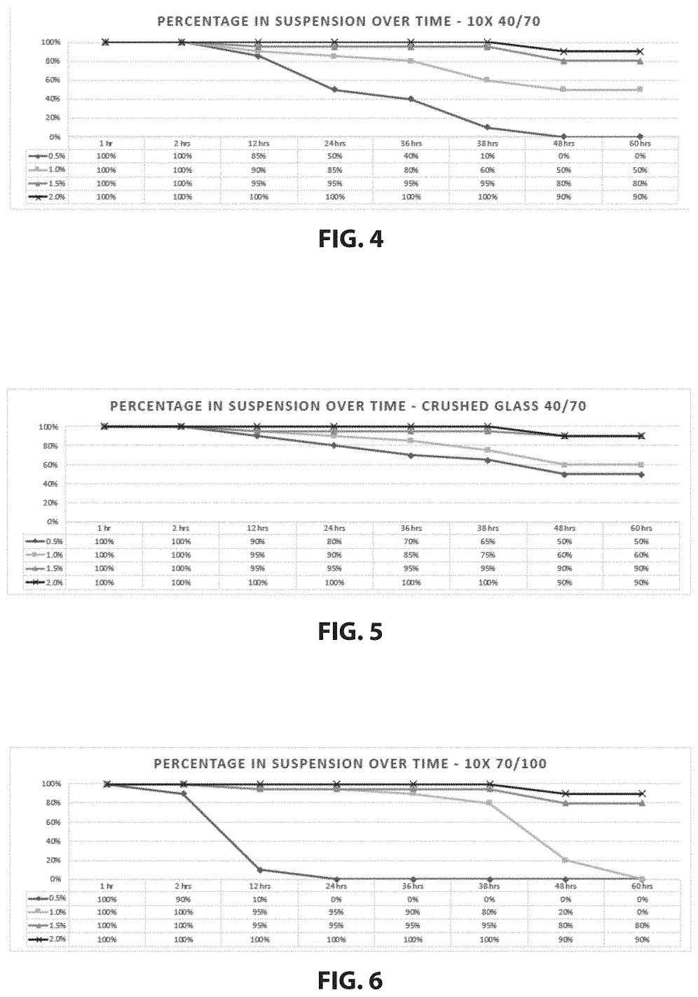

FIG. 4 is a graph showing the percentage of 10× 40/70 mineral solids (200 to 400 μm) in suspension over time in blast solutions having between 0.5 and 2% of the suspending agent added by weight.

FIG. 5 is a graph showing the percentage of Truabrasives® Crushed Glass 40/70 mineral solids (200 to 400 μm) in suspension over time in blast solutions having between 0.5 and 2% of the suspending agent added by weight.

FIG. 6 is a graph showing the percentage of 10× 70/100 mineral solids (100 to 200 μm) in suspension over time in blast solutions having between 0.5 and 2% of the suspending agent added by weight.

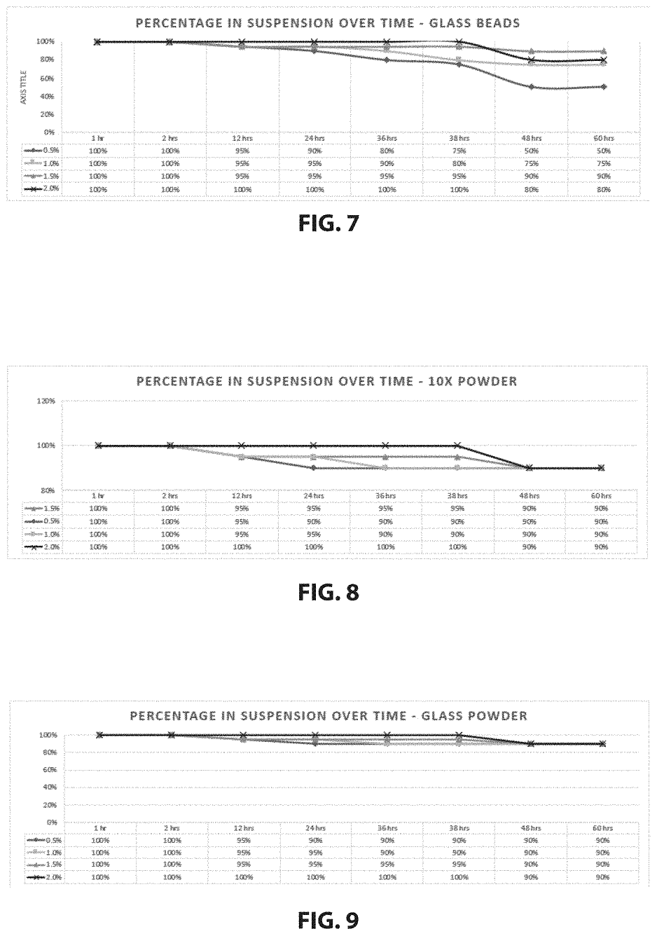

FIG. 7 is a graph showing the percentage of Swarco® Glass beads (100 to 200 μm) in suspension over time in blast solutions having between 0.5 and 2% of the suspending agent added by weight.

FIG. 8 is a graph showing the percentage of 10× Powder mineral solids (40 to 70 μm) in suspension over time in blast solutions having between 0.5 and 2% of the suspending agent added by weight.

FIG. 9 is a graph showing the percentage of Vitro Mineral LA500 Glass Powder (10 to 40 μm) in suspension over time in blast solutions having between 0.5 and 2% of the suspending agent added by weight.

### DETAILED DESCRIPTION OF THE DRAWINGS

With reference now to the drawings, and in particular FIGS. 1 through 9 thereof, example of the instant suspension medium for improved grit delivery in vapor blast operations employing the principles and concepts of the present suspension medium for improved grit delivery in vapor blast operations will be described. In each of the Figures shown, the suspending-agent added to the blast solution comprised xanthan gum at between 0.5% to 2.0% by weight. The suspending agent was added to the blast solution and then the like quantity of solid particles was added to each solution at a ratio of 3:1 grit to water by weight.

After initial agitation, each blast solution sat without agitation or mixing for up to 60 hours. Measurements were made as to the percentage of solid settling out of solution at the following intervals: 1 hour, 2 hours, 12 hours, 24 hours, 36 hours, 38 hours, 48 hours, and 60 hours. It should be noted that, absent any suspending-agent applied at all, it is known that all blast solutions settle 100% solids within one hour.

FIG. 1 is a table detailing the various solids, of varying sizes, typically used in blast operations for which the present data was compiled. Solids shown range in size from coarse (400 to 900 μm) to micro-fine (10 to 40 μm). Solids are generally mineral solids; garnet (i.e. (Fe, CA)₃Al₂(SiO₄)₃); and glass oxides, soda lime, or amorphous calcium aluminosilicate glass powder.

FIG. 2 presents data of suspension times of 10× 20/40, coarse mineral solids (at between 400 to 900 μm) shown in FIG. 1, in various blast solutions having 0.5% suspending-agent added by weight, 1.0% suspending-agent added by weight, 1.5% suspending agent added by weight, and 2.0% suspending-agent added by weight. The Y axis shows percentage of the solid remaining in solution at each of the time intervals shown on the X axis. Note that the time intervals are 1 hour, 2 hours, 12 hours, 24 hours, 36 hours, 38 hours, 48 hours, and 60 hours. The data shows that a blast solution having 2.0% suspending-agent by weight maintains 90% suspension for up to 60 hours, and 100% suspension through at least 38 hours. The blast solution having 1.5% suspending-agent fared almost as well until after 48 hours, after which a rapid decline of suspension was measured to 10% suspension at 60 hours.

FIG. 3 presents data of GMA XTREMEBLAST®, a garnet coarse solid (400 to 900 μm) in suspension in associated blast solutions over time. Here, blast solutions comprising both 1.5% and 2.0% suspending-agent by weight presented near identical settlement over time, maintaining over 90% suspension through 38 hours, whereafter suspension of solids dropped to 80% at 60 hours. Blast solution having 0.5% suspending-agent lasted up to 2 hours with around 90% particles in suspension, whereafter a rapid settlement was evinced and 0% solids remaining in suspension within 24 hours.

FIG. 4 presents data of 10× 40/70, medium sized solids (200 to 400 μm) in suspension in associated blast solutions over time. In like manner as evinced above, blast solution having 2.0% suspending-agent by weight maintained 90% or more solids in suspension up to 60 hours. Blast solution with 2.0% suspending-agent maintained 100% suspension until at least 38 hours. Blast solution having 1.5% suspending-agent by weight fared almost as well, showing 80% suspension maintained after 60 hours. Blast solution with 0.5% suspending-agent maintained 100% suspension at least up to 2 hours, and over 80% up to 24 hours.

FIG. 5 presents data of TRUABRASIVES® Crushed Glass (40/70), medium sized solids (200 to 400 μm), in suspension in associated blast solutions over time. Blast solutions having 1.5% and 2.0% suspending-agent maintaining about 90% suspension over 60 hours. Blast solution having 1.5% suspending agent settled approximately 5% after 12 hours but maintained up to 90% in suspension for the 60 hour period. All blast solutions mateine at least 45% suspension throughout the 60 hour period. Blast solution with 2.0% suspending-agent maintained 100% suspension until at least 38 hours.

FIG. 6 presents data of 10× 70/100, fine mineral solids (100 to 200 μm) in suspension in associated blast solutions over time. Blast solution with 2.0% suspending-agent maintained 90% suspension of solids over the 60 hour period, with 100% suspension maintained until at least 38 hours. Blast solution with 1.5% suspending-agent maintained 100% suspension for at least 2 hours, with small settlement thereafter, maybe 5% through 38 hours. Suspension dropped to 80% at 60 hours. Blast solution with 1% suspending-agent maintained similar data as the blast solution with 1.5% suspending-agent until 36 hours, whereafter settlement increased, 20% settled by 38 hours and 80% by 48 hours. Blast solution with 0.5% suspending-agent settled 10$ within 2 hours and was 100% settled within 24 hours.

FIG. 7 presents data of SWARCO® Glass Beads, fine solids (100 to 200 μm), in suspension in associated blast solutions over time. Data show that blast solution having 1.5% suspending-agent performed the best at maintaining suspension of solids at around 90% suspension maintained at 60 hours. However, blast solution having 2.0% suspending-agent maintained 100% suspension at least through 38 hours, whereas blast solution having 1.5% suspending-agent evinced perhaps 5% settlement after 12 hours. Blast solution having 1.0% suspending-agent maintained greater than 50% suspension up to the 60 hour period.

FIG. 8 presents data of 10× Powder, micro-fine mineral solids (40 to 70 μm), in suspension in associated blast solutions over time. All blast solutions maintained 90% suspension over 60 hours. Blast solution having 2.0% suspendin-agent maintained 100% suspension longest, with settlement or approximately 10% first apparent after 48 hours. All other blast solutions had 10% settlement evident after 12 hours.

FIG. 9 presents data of VITRO® Mineral LA500 Glass Powder, micro-fine solids (40 to 70 μm), in suspension in associated blast solutions over time. Results are similar to the results shown in FIG. 8. Blast solution having 2.0% suspending-agent maintained 100% suspension for at least 38 hours. All blast solutions maintained 90% suspension at least up to 60 hours.

What is claimed is:

1. A suspension medium for improved grit delivery in vapor blast operations comprising:
2% suspending-agent by weight;
98% water by weight; and
grit added at a weight ratio of 1 part grit to a range of 1 to 5 parts blast solution.

2. The suspension medium of claim 1 wherein the suspending-agent is a dispersant.

3. The suspension medium of claim 1 wherein the suspending-agent is a surfactant.

4. The suspension medium of claim 1 wherein suspending-agent increases the density of the water and thereby increases the buoyancy force of the suspended grit particles.

5. The suspension medium of claim 1 wherein the suspending-agent is a biodegradable compound.

6. The suspension medium of claim 5 wherein the suspending-agent is xanthan gum.

7. The suspension medium for improved grit delivery in vapor blast operations of claim 1 wherein the grit is added at a weight ratio of 1 part grit to 3 parts blast solution.

8. In an apparatus for wet blasting, a method for improved wet or vapor blast operations comprising addition of a suspending-agent to a blast solution interior to the blast pot wherein settling of grit particles within the blast solution is prevented without the need for agitation of the blast solution as would otherwise be required.

9. The method of claim 8 wherein an amount of the suspending-agent additional to the blast solution comprises between 1 to 3% of the suspending-agent by weight.

10. The method of claim 8 further comprising the step of adding grit to the blast solution at a range of ratios of 1:1 to 1:5 parts grit to water.

11. The method of claim 10 wherein the grit to blast solution ratio is 1 part grit to 3 parts water.
